(19) United States
(12) Patent Application Publication
(10) Pub. No.: US 2017/0363294 A1
(43) Pub. Date: Dec. 21, 2017

(54) PILOT PREMIX NOZZLE AND FUEL NOZZLE ASSEMBLY

(71) Applicant: General Electric Company, Schenectady, NY (US)

(72) Inventors: Neal William Grooms, Simpsonville, SC (US); James Harper, Greenville, SC (US); Yon Han Chong, Greer, SC (US)

(21) Appl. No.: 15/188,190

(22) Filed: Jun. 21, 2016

(51) Int. Cl. F23R 3/28; F02C 7/22

(52) U.S. Cl. CPC F23R 3/286; F02C 7/222; F05D 2220/32

(57) ABSTRACT

A premix pilot nozzle and fuel nozzle assembly are disclosed herein. The premix pilot nozzle includes a nozzle body having a forward wall axially spaced from an aft wall and an outer band that extends axially between the forward wall and the aft wall. An air tube extends coaxially within the nozzle body and defines a cooling air plenum within the nozzle body. A fuel tube extends coaxially within the nozzle body and circumferentially surrounds the air tube so as to define a fuel inlet plenum therebetween. A fuel distribution plenum is defined within the nozzle body and is in fluid communication with the fuel inlet plenum. The nozzle body further includes a plurality of premix tubes. Each premix tube extends helically around the fuel tube within the fuel distribution plenum. One or more of the premix tubes is in fluid communication with the fuel distribution plenum.

### FIELD OF THE INVENTION

The present invention generally involves a fuel nozzle assembly for a gas turbine combustor. More specifically, the invention relates to a pilot premix nozzle for a fuel nozzle assembly.

### BACKGROUND OF THE INVENTION

As requirements for gas turbine emissions have become more stringent, one approach to meeting such requirements is to move from diffusion flame combustors to combustors utilizing lean fuel and air mixtures using a fully premixed operations mode to reduce emissions of, for example, NOx and CO. These combustors are generally known in the art as Dry Low NOx (DLN), Dry Low Emissions (DLE) or Lean Pre Mixed (LPM) combustion systems.

Certain DLN type combustors include a plurality of primary fuel nozzles which are annularly arranged about a secondary or center fuel nozzle. The fuel nozzles are circumferentially surrounded by an annular combustion liner. The combustion liner defines an upstream combustion chamber and a downstream combustion chamber of the combustor. The upstream combustion chamber and the downstream combustion chamber may be separated by a throat portion of the combustion liner.

During operation of the combustor, the primary fuel nozzles may provide fuel to the upstream combustion chamber. Depending on the operational mode, the fuel from the primary fuel nozzles may be burned in the upstream combustion chamber or may be premixed with compressed air within the upstream combustion chamber for ignition in the downstream combustion chamber. The secondary fuel nozzle serves several functions in the combustor including supplying fuel and air mixture to the downstream combustion chamber for premixed mode operation, supplying fuel and air for a pilot flame supporting primary nozzle operation and providing transfer fuel for utilization during changes between operation modes.

In certain combustors, the secondary fuel nozzle may include a diffusion pilot nozzle disposed at a downstream end of the secondary fuel nozzle. The diffusion pilot nozzle provides a stream of fuel and air to the second combustion chamber and is employed for anchoring a secondary flame. However, in order to comply with various emissions requirements the fuel flow to the pilot fuel circuit may be reduced. As a result, the reduced fuel flow to the pilot fuel circuit may impact combustion dynamics and/or lean blow out limits.

### BRIEF DESCRIPTION OF THE INVENTION

Aspects and advantages of the invention are set forth below in the following description, or may be obvious from the description, or may be learned through practice of the invention.

One embodiment of the present invention is a pilot premix nozzle. The pilot premix nozzle includes a nozzle body. The nozzle body comprises a forward wall that is axially spaced from an aft wall and an outer band that extends axially between the forward wall and the aft wall. The aft wall includes an inner surface that is axially spaced from an outer surface. An air tube extends coaxially within the nozzle body and terminates at the inner surface of the aft wall. The air tube at least partially defines a cooling air plenum within the nozzle body. A fuel tube extends coaxially within the nozzle body and at least partially circumferentially surrounds the air tube. The fuel tube and the air tube define a fuel inlet plenum therebetween. A fuel distribution plenum is defined within the nozzle body and is in fluid communication with the fuel inlet plenum. The nozzle body also includes a plurality of premix tubes. Each premix tube of the plurality of premix tubes defines a respective premix passage through the nozzle body and includes an inlet defined along the forward wall and an outlet defined along the aft wall of the nozzle body. Each respective premix tube extends helically around the fuel tube within the fuel distribution plenum. One or more of the premix tubes of the plurality of premix tubes is in fluid communication with the fuel distribution plenum.

Another embodiment of the present disclosure is a fuel nozzle assembly. The fuel nozzle assembly includes an outer tube, an inner tube that extends coaxially within the outer tube, an intermediate tube that extends coaxially within the outer tube and that circumferentially surrounds and is radially spaced from the inner tube, and a premix pilot nozzle that is coupled to a downstream end of the outer tube via a nozzle ring. The premix pilot nozzle comprises a nozzle body. The nozzle body includes a forward wall that is axially spaced from an aft wall and an outer band that extends axially between the forward wall and the aft wall. The aft wall includes an inner surface that is axially spaced from an outer surface. An air tube is coupled at one end to the inner tube and extends coaxially within the nozzle body. The air tube terminates at the inner surface of the aft wall and at least partially defines a cooling air plenum within the nozzle body. A fuel tube is coupled at one end to the intermediate tube. The fuel tube extends coaxially within the nozzle body and circumferentially surrounds at least a portion of the air tube. The fuel tube and the air tube define a fuel inlet plenum therebetween. A fuel distribution plenum is defined within the nozzle body and is in fluid communication with the fuel inlet plenum. The nozzle body also includes a plurality of premix tubes. Each premix tube defines a premix passage through the nozzle body and includes a respective inlet that is defined along the forward wall and a respective outlet that is defined along the aft wall. Each premix tube extends helically around the fuel tube within the fuel distribution plenum. One or more of the premix tubes of the plurality of premix tubes is in fluid communication with the fuel distribution plenum.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 illustrates a schematic depiction of an embodiment of a gas turbine;

FIG. 2 illustrates a simplified cross-section of an exemplary combustor known in the art and which may incorporate one or more embodiments of the present disclosure;

FIG. 3 is a cross sectional side view of an exemplary fuel nozzle or fuel nozzle assembly as may be used in the combustor as shown in FIG. 2, according to at least one embodiment of the present disclosure;

FIG. 4 is a perspective view of a premix pilot nozzle of the fuel nozzle assembly as shown in FIG. 3, according to at least one embodiment of the present disclosure;

FIG. 5 is a perspective cross sectional view of the premix pilot nozzle as shown in FIG. 4, according to at least one embodiment of the present disclosure;

FIG. 6 is a cross sectioned perspective view of a portion of the tip portion of the premix pilot nozzle as taken along section lines A-A as shown in FIG. 4, according to at least one embodiment of the present disclosure:

FIG. 7 is a cross sectioned perspective view of a portion of the premix pilot nozzle as taken along section lines B-B as shown in FIG. 4, according to at least one embodiment of the present disclosure; and

FIG. 8 is a perspective view of a premix pilot nozzle of the fuel nozzle assembly as shown in FIG. 4, according to at least one embodiment of the present disclosure; and

FIG. 9 is an upstream view of the premix pilot nozzle as shown in FIG. 4, according to at least one embodiment of the present disclosure.

### DETAILED DESCRIPTION OF THE INVENTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

As used herein, the terms “first”, “second”, and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows. The term “radially” refers to the relative direction that is substantially perpendicular to an axial centerline of a particular component, and the term “axially” refers to the relative direction that is substantially parallel and/or coaxially aligned to an axial centerline of a particular component.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Each example is provided by way of explanation, not limitation. In fact, it will be apparent to those skilled in the art that modifications and variations can be made without departing from the scope or spirit thereof. For instance, features illustrated or described as part of one embodiment may be used on another embodiment to yield a still further embodiment. Thus, it is intended that the present disclosure covers such modifications and variations as come within the scope of the appended claims and their equivalents. Although exemplary embodiments of the present disclosure will be described generally in the context of a fuel nozzle assembly for a land based power generating gas turbine combustor for purposes of illustration, one of ordinary skill in the art will readily appreciate that embodiments of the present disclosure may be applied to any style or type of combustor for a turbomachine and are not limited to combustors or combustion systems for land based power generating gas turbines unless specifically recited in the claims.

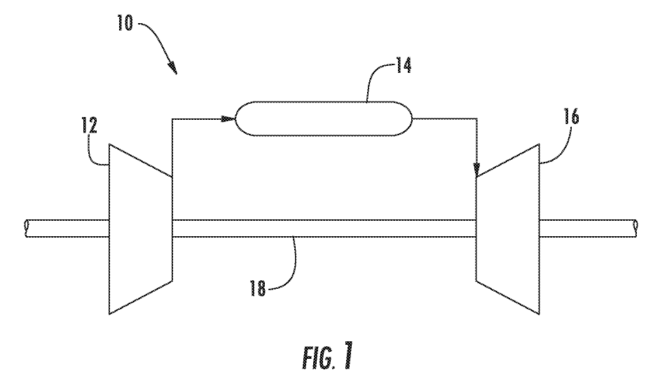

Referring to the drawings, FIG. 1 illustrates a schematic depiction of an embodiment of a gas turbine 10. The gas turbine 10 includes a compressor section 12, a combustion section 14, and a turbine section 16. The compressor section 12 and turbine section 16 may be coupled by a shaft 18. The shaft 18 may be a single shaft or a plurality of shaft segments coupled together to form the shaft 18. During operation, the compressor section 12 supplies compressed air to the combustion section 14. The compressed air is mixed with fuel and burned within the combustion section 14 to produce hot gases of combustion which flow from the combustion section 14 to the turbine section 16, wherein energy is extracted from the hot gases to produce work.

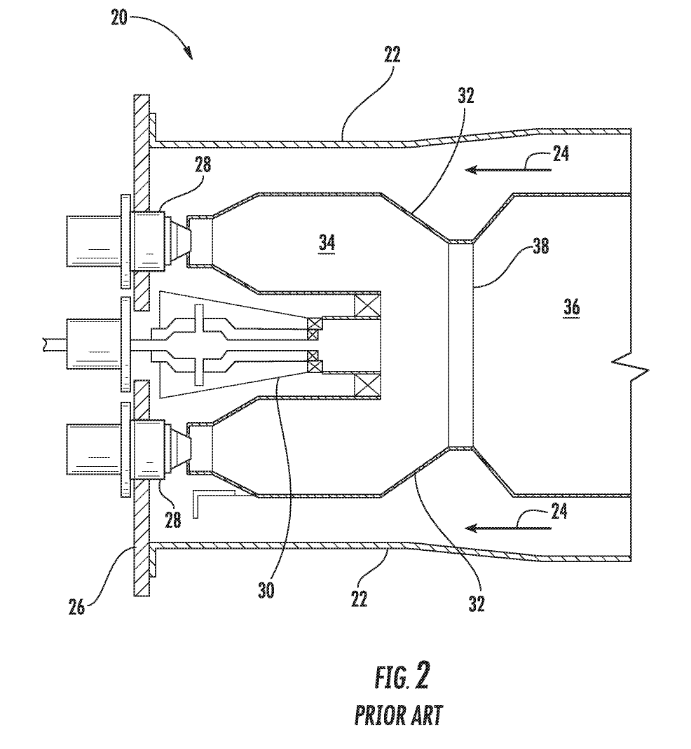

The combustion section 14 may include a plurality of combustors 20 (one of which is illustrated in FIG. 2) positioned in an annular array about a center axis of the gas turbine 10. FIG. 2 provides a simplified cross-section of an exemplary combustor 20 known in the art and which may incorporate one or more embodiments of the present disclosure. As shown in FIG. 2, a casing 22 surrounds the combustor 20 to contain compressed air 24 flowing from the compressor section 12 (FIG. 1). Multiple fuel nozzles are arranged across an end cover 26. For example, in particular embodiments, a plurality of primary fuel nozzles 28 is circumferentially spaced radially outwardly from a secondary fuel nozzle 30. A liner 32 extends downstream from the fuel nozzles 28, 30 and defines an upstream or forward combustion chamber 34 and a downstream or aft combustion chamber 36 which are separated by a throat or converging/diverging portion 38 of the liner 32.

During operation of the combustor 20, the primary fuel nozzles 28 may provide fuel to the upstream combustion chamber 34. Depending on the operational mode of the combustor 20, the fuel from the primary fuel nozzles 28 may be burned in the upstream combustion chamber 34 or may be premixed with the compressed air 24 within the upstream combustion chamber 34 for ignition in the downstream combustion chamber 36. The secondary fuel nozzle 30 serves several functions in the combustor 20 including supplying a fuel and air mixture to the downstream combustion chamber 36 for premixed mode operation, supplying fuel and air for a pilot flame which supports primary nozzle operation and providing transfer fuel for utilization during changes between operation modes.

FIG. 3 provides a cross sectional side view of an exemplary fuel nozzle or fuel nozzle assembly 100 as may be incorporated into the combustor 20 as shown in FIG. 2 as the secondary fuel nozzle 30, according to at least one embodiment of the present disclosure. The fuel nozzle 100 may be connected to the end cover 26 or may be breach loaded through an opening 40 defined in the end cover 26.

In various embodiments, as shown in FIG. 3, the fuel nozzle 100 includes an outer tube 102 having an upstream end portion 104 that is axially spaced from a downstream end portion 106 with respect to an axial centerline of the fuel nozzle 100. An inner tube 108 extends axially within the outer tube 102 and may be coaxially aligned with the outer tube 102 with respect to the axial centerline of the fuel nozzle 100. In particular embodiments, the inner tube 108 may be in fluid communication with an external compressed air supply (not shown). An intermediate tube 110 extends axially within the outer tube 102 and circumferentially surrounds the inner tube 108. The intermediate tube 110 may be coaxially aligned with the outer tube 102 and/or the inner tube 108 with respect to the axial centerline of the fuel nozzle 100. The intermediate tube 110 is radially spaced from the inner tube 108 so as to define a pilot fuel passage 112 therebetween. In particular embodiments, the intermediate tube 110 may be in fluid communication with an external fuel supply (not shown). The outer tube 102 is radially spaced from the intermediate tube 110 so as to define an annular air passage 114 therebetween. The annular air passage 114 may be in fluid communication with an external compressed air supply (not shown).

In particular embodiments, the fuel nozzle 100 may include a secondary intermediate tube 116 that extends axially within the outer tube 102 with respect to the axial centerline of the fuel nozzle 100. The secondary intermediate tube 116 circumferentially surrounds at least a portion of the intermediate tube 110 and defines a secondary fuel passage 118 within the outer tube 102. A plurality of fuel pegs 120 may be circumferentially spaced about the outer tube 102. Each fuel peg 120 may extend radially outwardly from the outer tube 102 with respect to the axial centerline of the fuel nozzle 100. One or more of the fuel pegs 120 may include one or more fuel injection orifices 122 which are in fluid communication with the secondary fuel passage 118.

In various embodiments, the fuel nozzle 100 includes a premix pilot nozzle 124. The premix pilot nozzle 124 includes a nozzle body 126 that extends axially through a nozzle ring 128. The nozzle ring 128 may be coupled to the downstream end portion 106 of the outer tube 102. In particular embodiments, the nozzle ring 128 may be formed as a singular or unitary component with the nozzle body 126.

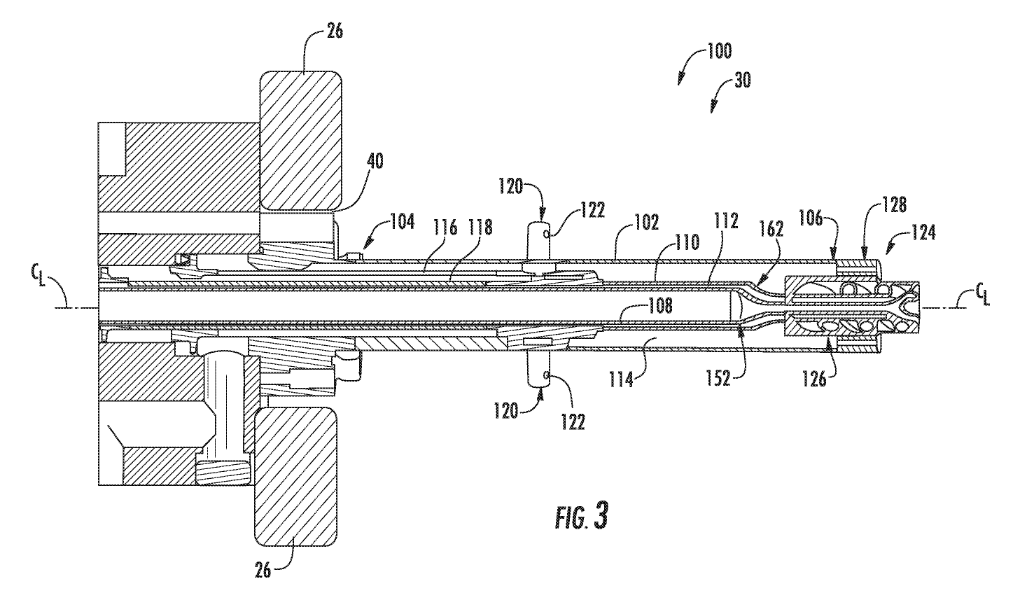

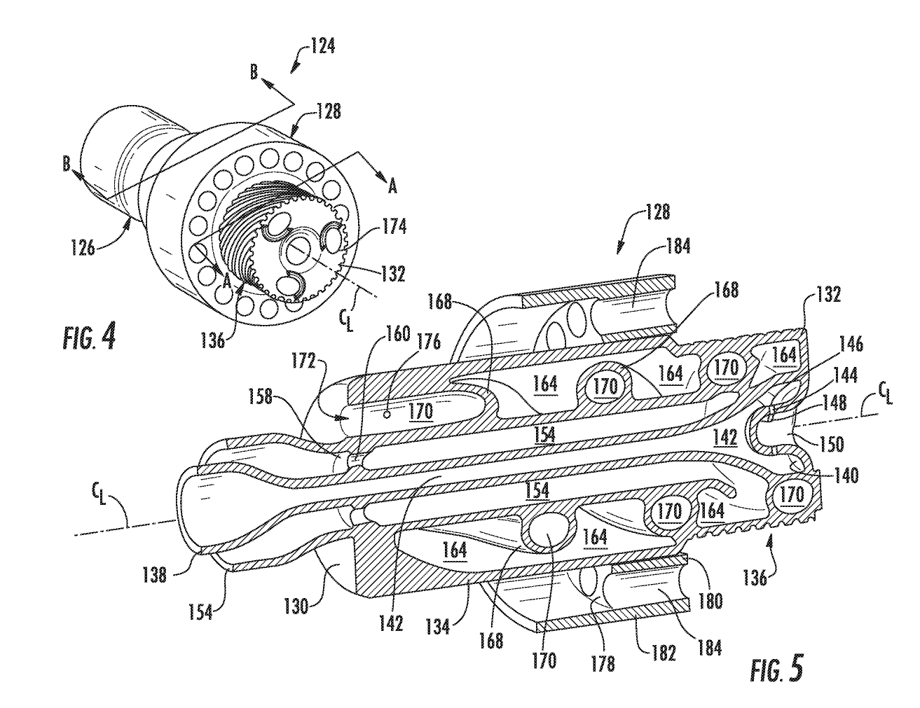

FIG. 4 provides a perspective view of the premix pilot nozzle 124 including the nozzle body 126 extending through the nozzle ring 128 according to at least one embodiment of the present disclosure. FIG. 5 provides a perspective cross sectional view of the premix pilot nozzle 124 including the nozzle ring 128 as shown in FIG. 3. As shown collectively in FIGS. 4 and 5, the nozzle body 126 includes a forward wall 130 that is axially spaced from an aft wall 132 with respect to an axial centerline of the nozzle body 126. As shown in FIG. 5, an outer band 134 extends axially between and circumferentially around the forward wall 130 and the aft wall 132 with respect to an axial centerline of the nozzle body 126. The outer band 134 may define a radially outer perimeter of the nozzle body 126. As shown in FIG. 5, the nozzle body 126 includes a tip portion 136. The tip portion 136 extends downstream from the nozzle ring 128 and terminates at the aft wall 132. In particular embodiments, the tip portion 136 of the nozzle body 126 may be cylindrical but is not limited to any particular shape unless otherwise recited in the claims.

In various embodiments, as shown in FIG. 5, the nozzle body 126 includes a first tube or air tube 138 that extends coaxially within the nozzle body 126 with respect to the axial centerline of the nozzle body 126. The air tube 138 terminates within the nozzle body 126 at or proximate to an inner surface 140 of the aft wall 132. A downstream portion of the air tube 138 may flare or diverge radially outwardly from the centerline of the nozzle body 126 at and/or proximate to the inner surface 140 of the aft wall 132. The air tube 138 and a portion of the inner surface 140 of the aft wall 132 define a cooling air plenum 142 within the nozzle body 126.

In at least one embodiment, the aft wall 132 defines a plurality of exhaust ports 144. Each exhaust port 144 includes a respective inlet 146 that is defined within or surrounded by the air tube 138 and a respective outlet 148 defined along an outer surface 150 of the aft wall 132. Each exhaust port 144 is in fluid communication with the cooling air plenum 142. As shown in FIG. 3, an upstream end portion 152 of the air tube 138 may be coupled to the inner tube 108 of the fuel nozzle 100 and may be in fluid communication with the external compressed air supply (not shown) via inner tube 108.

In various embodiments, as shown in FIG. 5, the nozzle body 126 includes a fuel tube 154. The fuel tube 154 extends coaxially within the nozzle body 126 with respect to the axial centerline of the nozzle body 126. The fuel tube 154 circumferentially surrounds at least a portion of the air tube 138 and is radially spaced from the air tube 138 so as to define a fuel inlet plenum 156 therebetween within the nozzle body 126. In at least one embodiment, a baffle or orifice plate 158 may extend radially between the air tube 138 and the fuel tube 154. The orifice plate may include a plurality of holes or metering holes 160 which may be sized and/or shaped to control flow of fuel into the fuel inlet plenum 156. As shown in FIG. 3, an upstream end portion 162 of the fuel tube 154 may be coupled to the intermediate tube 110 of the fuel nozzle 100 and may in fluid communication with the external fuel supply (not shown) so as to provide fuel to the fuel inlet plenum 156.

As shown in FIG. 5, the nozzle body 126 further includes or defines a fuel distribution plenum or void 164 which is defined inside or within the nozzle body 126. The fuel distribution plenum 164 is defined within the nozzle body 126 radially outwardly from the fuel tube 154 and as such radially outwardly from the fuel inlet plenum 156. The fuel distribution plenum 164 is separated from the fuel inlet plenum 156 via the fuel tube 154.

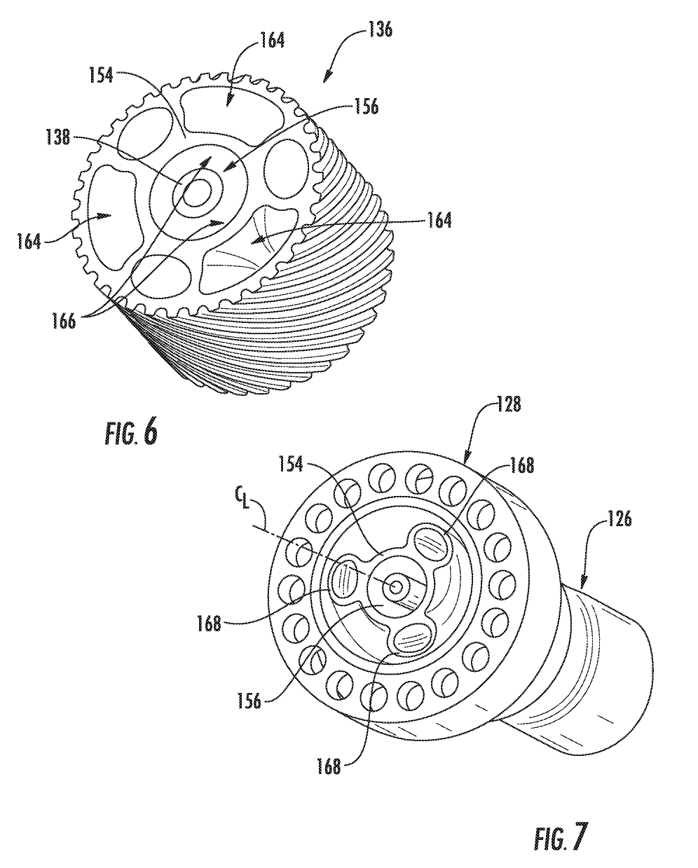

FIG. 6 provides a cross sectioned perspective view of a portion of the tip portion 136 of the premix pilot nozzle 124 as taken along section lines A-A as shown in FIG. 4. FIG. 7 provides a cross sectioned perspective view of a portion of the premix pilot nozzle 124 as taken along section lines B-B as shown in FIG. 4. As shown most clearly in FIG. 6, the fuel inlet plenum 156 is in fluid communication with the fuel distribution plenum 164 via a plurality of orifices or openings 166 which are circumferentially spaced about the axial centerline of the nozzle body 126. The openings 166 are defined proximate to or adjacent to a portion of the inner surface 140 of the aft wall 132.

In various embodiments, as shown in FIG. 5, the nozzle body 126 includes a plurality of premix tubes 168 disposed radially outwardly from the fuel tube 154 and/or from the fuel inlet plenum 156. Each premix tube 168 defines a respective premix passage 170 through and/or within the nozzle body 126. As shown collectively in FIGS. 5 and 7, the plurality of premix tubes 168 and as such to the respective premix passages 170 extend helically or wrap around the fuel tube 154 and/or the fuel inlet plenum 156 within the fuel distribution plenum 164 with respect to the axial centerline of the nozzle body 126.

As shown in FIGS. 4 and 5 collectively, each premix tube 168 and as such each premix passage 170 includes a respective inlet 172 (FIG. 5) defined along the forward wall 130 and a respective outlet 174 (FIG. 4) defined along the aft wall 132 of the tip portion 136. As shown in FIG. 4, the respective inlets 172 are circumferentially spaced along the forward wall 130 and annularly arranged about the axial centerline of the nozzle body 126. As shown in FIG. 4, the respective outlets 174 are circumferentially spaced along the aft wall 132 and annularly arranged about the axial centerline of the nozzle body 126. As shown in FIG. 5, each premix tube 168 and as such each premix passage 170 may be in fluid communication with the fuel distribution plenum 164 via one or more fuel ports 176 defined along each respective premix tube 168.

In various embodiments, as shown in FIG. 5, the nozzle ring 128 includes an upstream wall 178, a downstream wall 180 axially spaced from the upstream wall 178, an outer sleeve 182 that circumferentially surrounds the upstream and downstream walls 178, 180 and a plurality of thru-holes 184 that extend through the upstream and the downstream walls 178, 180. The plurality of thru-holes 184 is annularly arranged around and disposed radially outwardly from the outer band 134 of the nozzle body 126 and defined radially inwardly from the outer sleeve 182 of the nozzle ring 128. As shown in FIG. 3, the outer sleeve 182 may be coupled to the outer tube 102 of the fuel nozzle 100. In various embodiments, the plurality of thru-holes 184 is in fluid communication with the annular air passage 114.

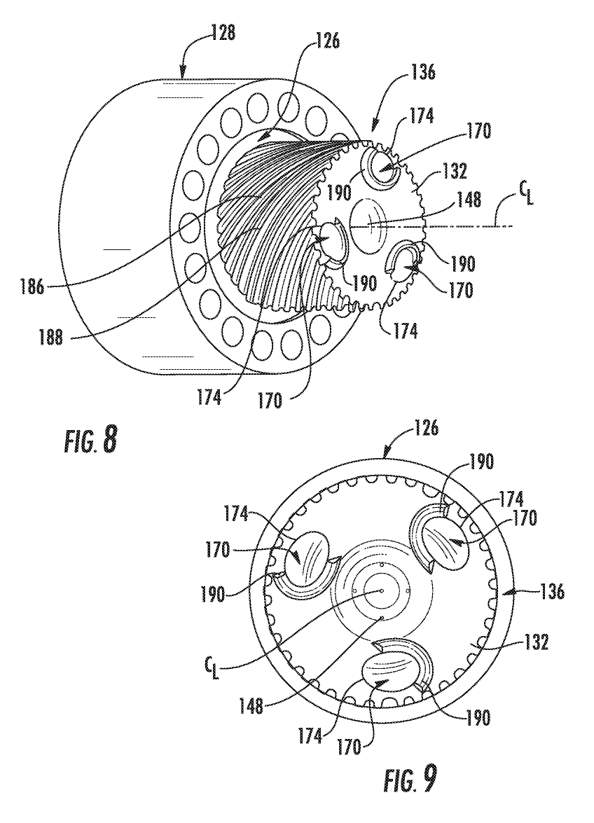

FIG. 8 provides a perspective view of the tip portion of the nozzle body 126 and the nozzle ring 128 according to at least one embodiment of the present disclosure. FIG. 9 provides an upstream view of the nozzle body 126 according to at least one embodiment of the present disclosure. In particular embodiments, as shown collectively in FIGS. 8 and 9, a portion of the aft wall 132 of the tip portion 136 which is defined radially inwardly from the respective outlets 174 of the premix passages 170 with respect to the centerline of the nozzle body 126 is dimpled, cupped or concaved axially inwardly along the axial centerline of the nozzle body 126 back towards the forward wall 130 or the nozzle ring 128. In particular embodiments as shown in FIG. 8, a radially outer surface 186 of the tip portion 136 of the nozzle body 126 may include a plurality of grooves 188 that extend helically along the outer surface 186 about the axial centerline of the nozzle body 126.

In at least one embodiment, as shown in FIGS. 8 and 9, one or more of the outlets 148 of the of the exhaust ports 144 (FIG. 5) is disposed within the dimpled or cupped portion of the aft wall 132. In at least one embodiment, as show collectively in FIGS. 8 and 9, one or more of the outlets 170 of the premix passages 170 is partially surrounded by a respective boss or collar 190 that extends axially downstream from the outer surface 150 of the aft wall 132. In particular embodiments, each of the outlets 174 of the premix passages 170 is partially surrounded by a respective boss or collar 190 that extends axially downstream from the outer surface 150 of the aft wall 132.

In at least one embodiment, the nozzle body 126 is formed as a singular body. In other words, the forward wall 130, the aft wall 132, the outer band 134, the air tube 138, the fuel tube 154 and the premix tubes 168 may all be formed from or as a singular body. In at least one embodiment, the nozzle body 126 and the nozzle ring 128 are formed from a singular body. For example, in particular embodiments, the nozzle body 126 with or without the nozzle ring 128 may be formed via an additive manufacturing process. The terms additive manufacturing or additively manufactured as used herein refers to any process which results in a useful, three-dimensional object and includes a step of sequentially forming the shape of the object one layer at a time. Additive manufacturing processes may include three-dimensional printing (3DP) processes, laser-net-shape manufacturing, direct metal laser sintering (DMLS), direct metal laser melting (DMLM), plasma transferred arc, freeform fabrication, etc.

During operation of the premix pilot nozzle 124, as shown collectively in FIGS. 3 through 9, air flows from the annular air passage 114 defined between the intermediate tube 110 and the outer tube 102, through the plurality of thru-holes 184 and through the respective premix passages 170. Fuel flows through the pilot fuel passage 112 and into the fuel inlet plenum 156 via the inner tube 108 and the fuel tube 154. The fuel flows into the fuel distribution plenum 164 via the plurality of orifices 166. The relatively cool fuel may provide cooling to a portion of the aft wall 132, thereby enhancing the mechanical life of the premix pilot nozzle 124. The fuel then flows from the fuel distribution plenum 164 and into the respective premix passages 170 via the respective fuel ports 176. The fuel and air mix within the respective premix passages 170 before being injected into the downstream combustion chamber 36 for combustion. The helical premix tubes 168 may impart angular swirl to the premixed fuel and air as it exits the respective outlets 174 of the premix passages 170, thereby encouraging further mixing of the fuel and air upstream from the downstream combustion chamber 36.

Compressed air may be routed through the inner tube 108 and into the cooling air plenum 142 defined within the air tube 138 of the nozzle body 126. The compressed air may then flow out of the cooling air plenum 142 via the plurality of exhaust ports 144. The exhaust ports 144 may be formed or angled so as to create a film of the compressed air across the outer surface 150 of the aft wall 132, thereby cooling the and/or providing a protective film across the outer surface 150 of the aft wall 132. The bosses 190 may prevent or block the cooling air from mixing with or otherwise interacting with the flow of premixed fuel and air as it exits the respective outlets 174 of the premix passages 170.

The premix pilot nozzle 124 as shown and described herein, may replace known high temperature and high Emissions diffusion type pilot nozzles which stabilize the flame in the downstream combustion chamber 36 at high temperature but at the expense of emissions. The premix pilot nozzle 124 as shown and described herein may replace known diffusion type premix pilot nozzles with a swirl stabilized premixed pilot nozzle. The premixed pilot nozzle 124 may result in more desirable emissions levels with the same flame stability provided by known diffusion type pilot nozzles while also providing improved dynamics and/or lean blow out limits.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A premix pilot nozzle, comprising:
a nozzle body, wherein the nozzle body comprises:
a forward wall axially spaced from an aft wall and an outer band that extends axially between the forward wall and the aft wall, wherein the aft wall includes an inner surface axially spaced from an outer surface;
an air tube that extends coaxially within the nozzle body and terminates at the inner surface of the aft wall, wherein the air tube defines a cooling air plenum within the nozzle body;
a fuel tube that extends coaxially within the nozzle body and circumferentially surrounds the air tube, wherein the fuel tube and the air tube define a fuel inlet plenum therebetween;
a fuel distribution plenum defined within the nozzle body and in fluid communication with the fuel inlet plenum; and
a plurality of premix tubes, wherein each premix tube defines a premix passage through the nozzle body and includes an inlet defined along the forward wall and an outlet defined along the aft wall, wherein each premix tube extends helically around the fuel tube within the fuel distribution plenum, wherein one or more of the premix tubes of the plurality of premix tubes is in fluid communication with the fuel distribution plenum.

2. The premix pilot nozzle as in claim 1, wherein the aft wall defines a plurality of exhaust ports positioned radially inwardly from the respective outlets of the premix tubes, wherein each of the exhaust ports is in fluid communication with the cooling air plenum.

3. The premix pilot nozzle as in claim 1, wherein a portion of the aft wall defined radially inwardly from the respective outlets of the premix tubes is dimpled inwardly along an axial centerline of the nozzle body towards the forward wall.

4. The premix pilot nozzle as in claim 1, wherein the cooling air plenum is partially defined by a portion of the inner surface of the aft wall.

5. The premix pilot nozzle as in claim 1, wherein at least one of the outlets of the premix tubes is partially surrounded by a boss that extends axially outwardly from the outer surface of the aft wall.

6. The premix pilot nozzle as in claim 1, wherein the nozzle body includes a tip portion which terminates at the aft wall, wherein a radially outer surface of the tip portion defines a plurality of grooves.

7. The premix pilot nozzle as in claim 6, wherein the plurality of grooves extends helically around the outer surface of the tip portion.

8. The premix pilot nozzle as in claim 1, further comprising a nozzle ring having an upstream wall, a downstream wall and an outer sleeve that circumferentially surround the upstream wall and the downstream wall, wherein the nozzle body extends coaxially through the nozzle ring.

9. The premix pilot nozzle as in claim 8, wherein the nozzle ring includes a plurality of thru-holes that extend through the upstream wall and the downstream wall, wherein the plurality of thru-holes are annularly arranged about the nozzle body.

10. The premix pilot nozzle as in claim 1, wherein the nozzle body is formed from a singular body.

11. A fuel nozzle assembly, comprising:
an outer tube;
an inner tube extending coaxially within the outer tube;
an intermediate tube extending coaxially within the outer tube and circumferentially surrounding the inner tube, wherein the intermediate tube is radially spaced from the outer tube; and
a premix pilot nozzle coupled to a downstream end of the outer tube via a nozzle ring, the premix pilot nozzle comprising a nozzle body, the nozzle body comprising:
a forward wall axially spaced from an aft wall and an outer band that extends axially between the forward wall and the aft wall, wherein the aft wall includes an inner surface axially spaced from an outer surface;
an air tube coupled to the inner tube and extending coaxially within the nozzle body, wherein the air tube terminates at the inner surface of the aft wall, wherein the air tube defines a cooling air plenum within the nozzle body;
a fuel tube coupled to the intermediate tube and extending coaxially within the nozzle body, wherein the fuel tube circumferentially surrounds at least a portion of the air tube, wherein the fuel tube and the air tube define a fuel inlet plenum therebetween;
a fuel distribution plenum defined within the nozzle body and in fluid communication with the fuel inlet plenum; and
a plurality of premix tubes, wherein each premix tube defines a premix passage through the nozzle body and includes an inlet defined along the forward wall and an outlet defined along the aft wall, wherein each premix tube extends helically around the fuel tube within the fuel distribution plenum, wherein one or more of the premix tubes of the plurality of premix tubes is in fluid communication with the fuel distribution plenum.

12. The fuel nozzle assembly as in claim 11, wherein the aft wall defines a plurality of exhaust ports positioned radially inwardly from the respective outlets of the premix tubes, wherein each of the exhaust ports is in fluid communication with the cooling air plenum.

13. The fuel nozzle assembly as in claim 11, wherein a portion of the aft wall defined radially inwardly from the respective outlets of the premix tubes is dimpled inwardly along an axial centerline of the nozzle body towards the forward wall.

14. The fuel nozzle assembly as in claim 11, wherein the cooling air plenum is partially defined by a portion of the inner surface of the aft wall.

15. The fuel nozzle assembly as in claim 11, wherein at least one of the outlets of the premix tubes is partially surrounded by a boss that extends axially outwardly from the outer surface of the aft wall.

16. The fuel nozzle assembly as in claim 11, wherein the nozzle body includes a tip portion which terminates at the aft wall, wherein a radially outer surface of the tip portion defines a plurality of grooves.

17. The fuel nozzle assembly as in claim 16, wherein the plurality of grooves extends helically around the outer surface of the tip portion.

18. The fuel nozzle assembly as in claim 11, wherein the nozzle ring includes an upstream wall, a downstream wall and an outer sleeve that circumferentially surrounds the upstream wall and the downstream wall.

19. The fuel nozzle assembly as in claim 18, wherein the nozzle ring includes a plurality of thru-holes that extend through the upstream wall and the downstream wall, wherein the plurality of thru-holes are annularly arranged about the nozzle body.

20. The fuel nozzle assembly as in claim 11, wherein the nozzle body is formed from a singular body.
